(19) United States
(12) Patent Application Publication
(10) Pub. No.: US 2013/0052459 A1
(43) Pub. Date: Feb. 28, 2013

(54) COMBINING STRUCUTRE OF THREE-DIMENSIONAL PAPER BOX

(71) Applicant: Jeffery Wang, New Taipei City (TW)

(72) Inventor: Jeffery Wang, New Taipei City (TW)

(73) Assignee: GOLDEN ARROW PRINTING, CO., LTD.

(21) Appl. No.: 13/460,800

(22) Filed: Apr. 30, 2012

(30) Foreign Application Priority Data
Aug. 22, 2011 (TW) 100215652

(51) Int. Cl. B32B 27/36; B32B 27/40; B32B 27/32

(52) U.S. Cl. 428/349

(57) ABSTRACT

A combining structure of a three-dimensional paper box includes a flexible paper sheet, a first adhesive film, a second adhesive film and a heating means. The flexible paper sheet has a plurality of folded lines for allowing the flexible paper sheet to be folded into a three-dimensional construction as well as a first adhesive surface and a second adhesive surface both located aside the folded lines. The first adhesive film is combined on the first adhesive surface. The second adhesive film is combined on the second adhesive surface. The heating means is applied on the first adhesive film and the second adhesive film to thereby combine the first adhesive surface and the second adhesive surface together.

### BACKGROUND OF THE INVENTION

1. Field of the Invention

The present invention relates to a paper product, and in particular to a combining structure of a three-dimensional paper box.

2. Description of Prior Art

External appearance of a product gives a great impression on customers and makes the customers to generate a motive for buying the product. Especially, a packaging box improves the safety and positioning of the product in transporting the product, so that the integrity of the product can be kept. Further, a well-designed packaging box makes customers to favor it.

A portion of the outer surfaces of a packaging box is usually printed with patterns. At least two paper sheets are combined with each other to form a three-dimensional paper box. The paper box is used for separating or supporting the products. The existing three-dimensional paper box is formed by folding different paper sheets and combining these folded paper sheets together via an adhesive. However, in practice, an adhesive is manually applied between two paper sheets, which makes the speed of adhering paper sheets low. Further, combining the paper sheets by the adhesive takes a lot of time and labor. Even though being combined with each other, the two paper sheets may be separated from each other. As a result, the quality of the packaging box is deteriorated, and the image of the product is negatively affected.

In order to solve the above-mentioned problems, the present Inventor proposes a novel and reasonable structure based on his expert knowledge and deliberate researches.

### SUMMARY OF THE INVENTION

The present invention is to provide a combining structure of a three-dimensional paper box, whereby the combining process of the paper box can be simplified and the paper sheets can be combined and welled positioned.

The present invention is to provide a combining structure of a three-dimensional paper box, whereby the speed of adhering paper sheets and the strength of the final product are increased.

The present invention provides a combining structure of a three-dimensional paper box, including a flexible paper sheet, a first adhesive film, a second adhesive film and a heating means. The flexible paper sheet has a plurality of folded lines for allowing the flexible paper sheet to be folded into a three-dimensional construction as well as a first adhesive surface and a second adhesive surface both located aside the folded lines. The first adhesive film is combined on the first adhesive surface. The second adhesive film is combined on the second adhesive surface. The heating means is applied on the first adhesive film and the second adhesive film to thereby combine the first adhesive surface and the second adhesive surface together.

The present invention provides a combining structure of a three-dimensional paper box, including a first flexible paper sheet, a first adhesive film, a second flexible paper sheet, a second adhesive film and a heating means. The first flexible paper sheet has at least one folded line for allowing the first flexible paper sheet to be folded into a three-dimensional construction and a first adhesive surface located aside the folded line. The first adhesive film is combined on the first adhesive surface. The second flexible paper sheet comprises a second adhesive surface. The second adhesive film is combined on the second adhesive surface. The heating means is applied on the first adhesive film and the second adhesive film to thereby combine the first adhesive surface and the second adhesive surface together.

In comparison with prior art, according to the present invention, two opposite surfaces of the flexible paper sheet are provided with an adhesive film (thermoplastic sheet) respectively. The heating means (such as a high-frequency heating process or a supersonic heating process) is used to melt the adhesive films to thereby combine the two opposite surfaces together to form a three-dimensional construction. The high-frequency heating process or the supersonic heating process has a fast melting speed and a short combining time. Further, the strength of the two combined adhesive films is good. Therefore, the combining process of the three-dimensional paper box is simplified. The adhering speed and the strength of the combined paper sheets are increased. Thus, the paper sheets can be well positioned. On the other hand, the combining structure of the present invention is used to combine two flexible paper sheets to thereby form various three-dimensional paper boxes with different spatial constructions. Therefore, the practicability of the present invention is increased.

### BRIEF DESCRIPTION OF DRAWING

FIG. 1 is an exploded view showing the combining structure of the three-dimensional paper box according to the present invention;

FIG. 2 is an assembled view showing the combining structure of the three-dimensional paper box according to the present invention;

FIG. 3 is a schematic view showing the operating aspect of the combining structure of the three-dimensional paper box according to the present invention;

FIG. 4 is a schematic view showing another operating aspect of the combining structure of the three-dimensional paper box according to the present invention;

FIG. 5 is a cross-sectional view showing the combining structure of the three-dimensional paper box according to another embodiment of the present invention;

FIG. 6 is a schematic view showing an operating aspect of the combining structure of the three-dimensional paper box according to another embodiment of the present invention; and

FIG. 7 is a cross-sectional view showing the combining structure of the three-dimensional paper box according to a further embodiment of the present invention.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

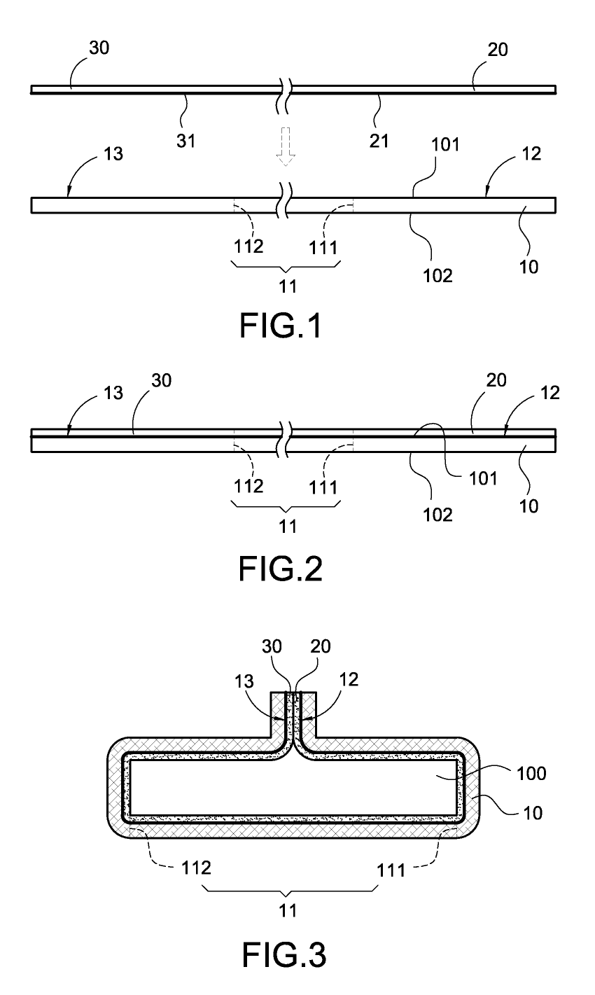

Please refer to FIGS. 1 to 3. FIG. 1 is an exploded view showing the combining structure of the three-dimensional paper box according to the present invention. FIG. 2 is an assembled view showing the combining structure of the three-dimensional paper box according to the present invention. FIG. 3 is a schematic view showing the operating aspect of the combining structure of the three-dimensional paper box according to the present invention. The combining structure of the three-dimensional paper box according to the present invention includes a flexible paper sheet 10, a first adhesive film 20, a second adhesive film 30, and a heating means.

The flexible paper sheet 10 is a paper sheet such as a white cardboard or a cardboard with any patterns. The flexible paper sheet 10 comprises a first surface 101 and a second surface 102 opposite to the first surface 101. The flexible paper sheet 10 has a plurality of folded lines 11 for allowing the flexible paper sheet 10 to be folded into a three-dimensional construction as well as a first adhesive surface 12 and a second adhesive surface 13 both located aside the folded lines 11. The folded lines 11 comprise a first folded line 111 and a second folded line 112. The first adhesive surface 12 is located outside the first folded line 111, and the second adhesive surface 13 is located outside the second folded line 112.

It should be noted that, there are two folded lines 11 in the present embodiment. The first adhesive surface 12 is located on the first surface 101. In practice, the number and locations of the folded lines 11 can be varied based on practical demands. On the other hand, the second adhesive surface 13 may be located on the first surface 101 on the same side of the first adhesive surface 12. Alternatively, the second adhesive surface 13 may be located on the second surface 102 on the different side of the first adhesive surface 12.

The first adhesive film 20 is combined on the first adhesive surface 12. The second adhesive film 30 is combined on the second adhesive surface 13. The first adhesive film 20 further comprises a hot-melt adhesive layer 21 provided between the first adhesive film 20 and the first adhesive surface 12. Similarly, the second adhesive film 30 further comprises a second hot-melt adhesive layer 31 provided between the second adhesive film 30 and the second adhesive surface 13. After subjected to a hot pressing process, the first adhesive film 20 and the second adhesive film 30 are combined on the flexible paper sheet 10 via the first hot-melt adhesive layer 21 and the second hot-melt adhesive layer 31 respectively.

In the present embodiment, the first adhesive film 20 and the second adhesive film 30 are located on the same adhesive film covering the whole surface of the flexible paper sheet 10. In practice, the first adhesive film 20 and the second adhesive film 30 may be provided to be separated from each other. That is, the adhesive film is merely provided on the first adhesive surface 12 and the second adhesive surface 13, and no adhesive film is provided between the first adhesive surface 12 and the second adhesive surface 13.

Further, each of the first adhesive film 20 and the second adhesive film 30 is a thermoplastic sheet that can be melted by a high-frequency heating process or a supersonic heating process, such as any one of polyvinyl chloride (PVC), ethylene vinyl acetate (EVA), polyethylene terephthalate (PET), polyurethane (PU), polyethylene (PE) and the like.

The heating means is applied to the first adhesive film 20 and the second adhesive film 30.

The heating means may be embodied as a high-frequency heating process or a supersonic heating process for hot-melting the first adhesive film 20 and the second adhesive film 30, thereby combining the first adhesive surface 12 and the second adhesive surface 13 together. In this way, the flexible paper sheet 10 can be folded into a three-dimensional construction in which a three-dimensional space 100 is formed.

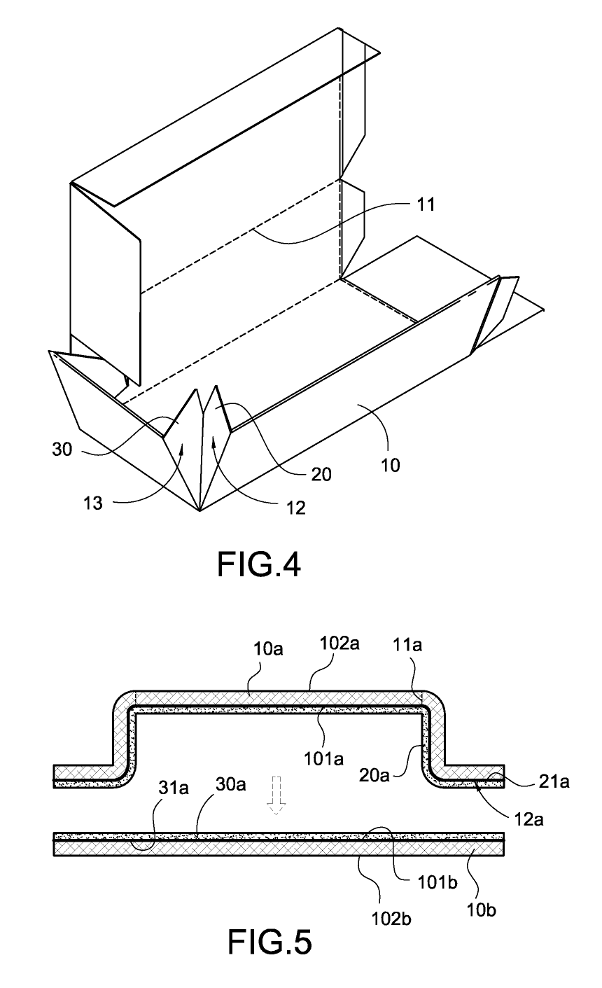

Please refer to FIG. 4, which is a schematic view showing another operating aspect of the combining structure of the three-dimensional paper box according to the present invention. The present embodiment is substantially the same as the first embodiment except for the fact that the flexible paper sheet 10 has a plurality of folded lines 11 for allowing the flexible paper sheet 10 to be folded into a box. The first adhesive surface 12 and the second adhesive surface 13 are located on the outer surfaces of the box. Then, the heating means (such as a high-frequency heating process, a supersonic heating process, or an infrared heating process) is applied to the first adhesive film 20 and the second adhesive film 30, thereby combining the first adhesive surface 12 and the second adhesive surface 13 to form the box.

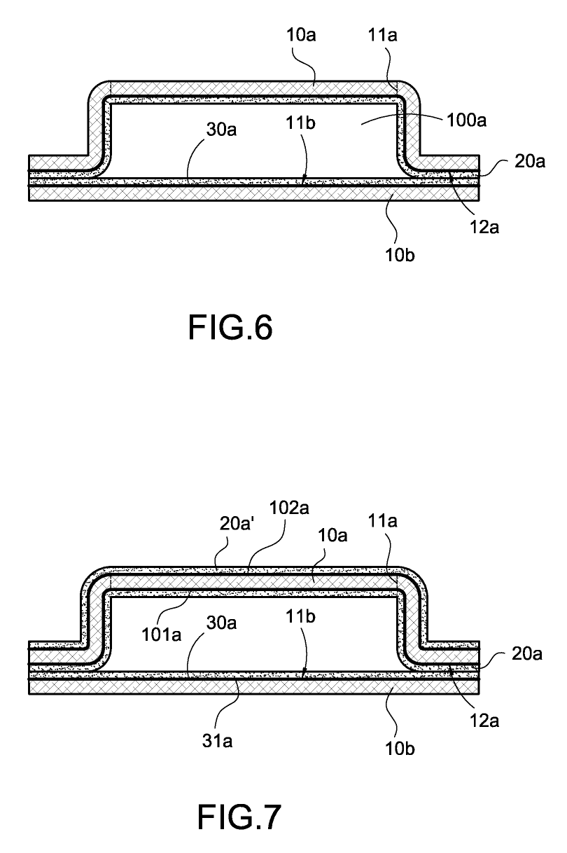

Please refer to FIGS. 5 and 6. FIG. 5 is a cross-sectional view showing the combining structure of the three-dimensional paper box according to another embodiment of the present invention, and FIG. 6 is a schematic view showing an operating aspect of the combining structure of the three-dimensional paper box according to another embodiment of the present invention. The difference between the present embodiment and the first embodiment lies in that two flexible paper sheets are combined together to form a three-dimensional construction. The combining structure includes a first flexible paper sheet 10a, a first adhesive film 20a, a second flexible paper sheet 10b, a second adhesive film 30a, and a heating means. Each of the first flexible paper sheet 10a and the second flexible paper sheet 10b is a paper sheet. Each of the first adhesive film 20a and the second adhesive film 30a is a thermoplastic sheet, which can be melted by a high-frequency heating process or a supersonic heating process. The structure and material of the first adhesive film 20a and the second adhesive film 30a are substantially the same as those of the first embodiment, so that the redundant description thereof is omitted for simplicity.

The first flexible paper sheet 10a comprises at least one folded line 11a for allowing the first flexible paper sheet 10a to be folded into a three-dimensional construction and a first adhesive surface 12a located aside the folded line 11a. The first adhesive film 20a is combined on the first adhesive surface 12a. The first flexible paper sheet 10a comprises a first surface 101a and a second surface 102a opposite to the first surface 101a. The first adhesive surface 12a is provided on the first surface 101a or the second surface 102a. The first adhesive film 20a further comprises a first hot-melt adhesive layer 21 a provided between the first adhesive film 20a and the first adhesive surface 12a.

The second flexible paper sheet 10b comprises a third surface 101b, a fourth surface 102b opposite to the third surface 101b, and a second adhesive surface 11b located on the third surface 101b or the fourth surface 102b. The second adhesive film 30a comprises a second hot-melt adhesive layer 31a provided between the second adhesive film 30a and the second adhesive surface 11b, thereby combining the second adhesive film 30a onto the second adhesive surface 11b.

Similarly, the heating means (such as a high-frequency heating process, a supersonic heating process, or an infrared heating process) is applied to the first adhesive film 20a and the second adhesive film 30a, thereby combining the first adhesive surface 12a and the second adhesive surface 11b together. In this way, the first flexible paper sheet 10a and the second flexible paper sheet 10b can be folded and adhered to each other, thereby forming a three-dimensional space 100a.

Please refer to FIG. 7, which is a cross-sectional view showing the combining structure of the three-dimensional paper box according to a further embodiment of the present invention. The difference between the present embodiment and the previous embodiment lies in that: the first surface 101a and the second surface 102a of the first flexible paper sheet 10a are combined with a first adhesive film 20a, 20a′ respectively. The second surface 102a allows another flexible paper sheet to be combined therewith. In this way, various three-dimensional paper boxes can be designed to have different spatial constructions.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A combining structure of a three-dimensional paper box, including:
a flexible paper sheet having a plurality of folded lines for allowing the flexible paper sheet to be folded into a three-dimensional construction as well as a first adhesive surface and a second adhesive surface both located aside the folded lines;
a first adhesive film combined on the first adhesive surface;
a second adhesive film combined on the second adhesive surface; and
a heating means applied on the first adhesive film and the second adhesive film to thereby combine the first adhesive surface and the second adhesive surface together.

2. The combining structure of a three-dimensional paper box according to claim 1, wherein the flexible paper sheet comprises a first surface and a second surface opposite to the first surface, the first adhesive surface is located on the first surface.

3. The combining structure of a three-dimensional paper box according to claim 1, wherein the second adhesive surface is located on the first surface.

4. The combining structure of a three-dimensional paper box according to claim 1, wherein the second adhesive surface is located on the second surface.

5. The combining structure of a three-dimensional paper box according to claim 1, wherein the first adhesive film further comprises a first hot-melt adhesive layer provided between the first adhesive film and the first adhesive surface.

6. The combining structure of a three-dimensional paper box according to claim 1, wherein the second adhesive film further comprises a second hot-melt adhesive layer provided between the second adhesive film and the second adhesive surface.

7. The combining structure of a three-dimensional paper box according to claim 1, wherein the heating means is any one of a high-frequency heating process, a supersonic heating process, and an infrared heating process.

8. The combining structure of a three-dimensional paper box according to claim 1, wherein the first adhesive film and the second adhesive film are located on the same adhesive film.

9. The combining structure of a three-dimensional paper box according to claim 1, wherein each of the first adhesive film and the second adhesive film is a thermoplastic sheet.

10. The combining structure of a three-dimensional paper box according to claim 9, wherein the thermoplastic sheet is any one of polyvinyl chloride (PVC), ethylene vinyl acetate (EVA), polyethylene terephthalate (PET), polyurethane (PU) and polyethylene (PE).

11. A combining structure of a three-dimensional paper box, including:
a first flexible paper sheet having at least one folded line for allowing the first flexible paper sheet to be folded into a three-dimensional construction and a first adhesive surface located aside the folded line;
a first adhesive film combined on the first adhesive surface;
a second flexible paper sheet comprising a second adhesive surface;
a second adhesive film combined on the second adhesive surface; and
a heating means applied on the first adhesive film and the second adhesive film to thereby combine the first adhesive surface and the second adhesive surface together.

12. The combining structure of a three-dimensional paper box according to claim 11, wherein the first flexible paper sheet comprises a first surface and a second surface opposite to the first surface.

13. The combining structure of a three-dimensional paper box according to claim 12, wherein the first adhesive surface is located on the first surface.

14. The combining structure of a three-dimensional paper box according to claim 12, wherein the first adhesive surface is located on the second surface.

15. The combining structure of a three-dimensional paper box according to claim 11, wherein the first adhesive film further comprises a first hot-melt adhesive layer provided between the first adhesive film and the first adhesive surface.

16. The combining structure of a three-dimensional paper box according to claim 11, wherein the second adhesive film further comprises a second hot-melt adhesive layer provided between the second adhesive film and the second adhesive surface.

17. The combining structure of a three-dimensional paper box according to claim 11, wherein the second flexible paper sheet comprises a third surface and a fourth surface opposite to the third surface, the second adhesive surface is located on the third surface, and the second adhesive surface is located on the fourth surface.

18. The combining structure of a three-dimensional paper box according to claim 11, wherein the heating means is any one of a high-frequency heating process, a supersonic heating process, and an infrared heating process.

19. The combining structure of a three-dimensional paper box according to claim 11, wherein each of the first adhesive film and the second adhesive film is a thermoplastic sheet.

20. The combining structure of a three-dimensional paper box according to claim 19, wherein the thermoplastic sheet is any one of polyvinyl chloride (PVC), ethylene vinyl acetate (EVA), polyethylene terephthalate (PET), polyurethane (PU) and polyethylene (PE).
